(19) United States
(12) Patent Application Publication
(10) Pub. No.: US 2014/0267192 A1
(43) Pub. Date: Sep. 18, 2014

(54) INFORMATION INPUTTING PEN

(71) Applicants: Yasuhiro Matsuura, Osaka-shi (JP); Shunsuke Nagasawa, Osaka-shi (JP); Qian Yan, Osaka-shi (JP); Tomohiko Nishimura, Osaka-shi (JP); Shinichi Miyazaki, Osaka-shi (JP)

(72) Inventors: Yasuhiro Matsuura, Osaka-shi (JP); Shunsuke Nagasawa, Osaka-shi (JP); Qian Yan, Osaka-shi (JP); Tomohiko Nishimura, Osaka-shi (JP); Shinichi Miyazaki, Osaka-shi (JP)

(73) Assignee: SHARP KABUSHIKI KAISHA, Osaka-shi, Osaka (JP)

(21) Appl. No.: 14/352,974

(22) PCT Filed: Aug. 27, 2012
(86) PCT No.: PCT/JP2012/005352

§ 371 Date: Apr. 18, 2014

(30) Foreign Application Priority Data
Oct. 20, 2011 (JP) 2011-231181

(51) Int. Cl. G06F 3/0354; G06F 3/044; G06F 3/041

(52) U.S. Cl. CPC G06F 3/03545; G06F 3/0416; G06F 3/044; G06F 2203/0381; G06F 2203/04106
USPC 345/179

(57) ABSTRACT

A stylus pen is obtained that allows accurate detection of a touched position regardless of the tilt of the stylus pen at a time of a touch operation on a capacitive touch panel. A stylus pen 100 comprises a pen body section 103 constituted of a non-conductive member and held by an operator, a pen tip section 102 formed, on one end of the pen body section 103, to taper toward the tip side, and a spherical member 101 constituted of a conductive member and mounted on a tip of the pen tip section, where a contact member is mounted on the pen body section such that a hand of an operator contacts the contact member when the operator holds the pen body section, and the contact member and the spherical member are connected by a conducting wire penetrating through the pen body section and the pen tip section.

### TECHNICAL FIELD

The present invention relates to an information inputting pen, and specifically is related to an information inputting pen used for inputting information in a capacitive touch panel.

### BACKGROUND ART

Conventionally, there are many types of conventional touch panels, such as resistive film, infrared, and ultrasonic type. However, in recent years, the capacitive type is attracting attention, which is used in mobile phones.

In a touch panel using a capacitive type, by contacting a finger or an information inputting pen (hereinafter, referred to also as a stylus pen) on the touch surface of a touch panel, capacitance is formed between an electrode of the touch panel and the stylus pen, and by detecting the amount of change in micro-current that flows through the capacitance, a contact position at which the stylus pen contacts with the touch screen is detected.

If the stylus pen is made completely of brass or steel, the configuration becomes simple and the stylus pen can be manufactured at low cost.

FIG. 10 is a diagram describing a touch panel apparatus using a convention stylus pen, and is a perspective view illustrating the exterior of the touch panel apparatus.

This touch panel apparatus 201 has a capacitive touch panel 110 and a stylus pen 200 used for inputting information in a touch panel 110, and the touch panel apparatus is configured to detect a position touched by the stylus pen on the touch surface when the stylus pen 200 contacts or is approximated to a touch surface 111 of the touch panel 110. The stylus pen 200 is formed with metallic material such as brass and steel.

Further, in general, such a touch panel apparatus 201 is integrated with a display apparatus (not shown), and the touch surface of the touch panel apparatus 201 is disposed to be stacked on the display surface of the display apparatus.

In an information input apparatus where such a touch panel apparatus 201 and a display apparatus are integrated, an operator can input information by performing a touch operation to an area displaying an operation button on the display surface of the display apparatus.

Patent Literature 1 discloses a stylus pen focused on a tip of a pen being electrically connected to a finger, and the operability of the pen.

FIG. 11 is a diagram describing a stylus pen disclosed in Patent Literature 1. FIG. 11(a) illustrates the exterior of this stylus pen. FIG. 11(b) illustrates the cross-sectional structure of the pen tip section of this stylus pen.

This stylus pen 1 comprises a pen body 1 held by an operator, and a conductive pen tip 2 formed on the tip section of the pen body 1. On the outer circumference section of the pen body 1, a conductive member 4 is disposed at the portion generally held by a hand, so as to form a conductive portion 5 that is electrically connected to the conductive pen tip 2. Other parts of the pen body 1 are formed as a non-conductive section 3 such as a resin molded item.

For the stylus pen 1 with such a configuration, the position of capacitance formed between an electrode of a capacitive touch panel apparatus and an operator can be determined by the pen tip, and input of extremely accurate positional information is made possible. Further, in FIG. 11(b), P is a touch surface of a touch panel display.

Furthermore, a stylus pen used in a capacitive touch panel apparatus is disclosed in Patent Literature 2.

FIG. 12 illustrates this stylus pen disclosed in Patent Literature 2.

This stylus pen 20 is used for an operator to contact the tip section thereof to the capacitive touch panel 30 with the stylus pen in his hand to input characters and diagrams in a touch panel 30.

The stylus pen 20 comprises a pen body 21, a pen tip section 22, and a conductive section 23 made of metal. The conductive section 23 is disposed on a grip section that an operator holds, and the pen tip section 22 and the conductive section 23 are electrically connected by a predetermined conductive member. The pen tip section 22 is the part that contacts an insulating layer 31 when inputting characters and diagrams, and is constituted of a conductive substance such as aluminum.

The touch panel 30 has a configuration where a base material 33, a transparent conductive film 32, and the insulating layer 31 are stacked on an LCD display section, which is not shown.

### Patent Literature

Patent Literature 1: Japanese Laid-Open Publication No. 10-171579
Patent Literature 2: Japanese Laid-Open Publication No. 2010-61351

### SUMMARY OF INVENTION

### Technical Problem

However, a conventional stylus pen may cause an inconvenience depending upon the way an operator holds a pen in a high precision touch panel.

The way a pen is held varies depending on the person, such as a person holding a pen straight and a person holding a pen tilted. There is a problem where the difference in the way a pen is held as described above becomes a cause in dispersion of detected touched positions in a high precision touch panel that detects a change in capacitance at high sensitivity.

This problem will be described in detail below.

FIG. 13 is a diagram describing a touch operation in the convention touch panel apparatus illustrated in FIG. 10. FIG. 13(a) illustrates a state where this stylus pen is held vertically with respect to a touch surface to perform a touch operation. FIG. 13(b) illustrates a distribution of sizes of change in capacitance that are detected at a touched position and in the vicinity thereof of a touch panel with contour lines Lc1. FIG. 13(c) illustrates the sizes S of change in capacitance in the horizontal direction with a graph G1.

FIG. 14 is a diagram describing a touch operation in the conventional touch panel apparatus illustrated in FIG. 10. FIG. 14(a) illustrates a state where this stylus pen is tilted diagonally with respect to a touch surface to perform a touch operation. FIG. 14(b) illustrates a distribution of sizes of change in capacitance that are detected at a touched position and in the vicinity thereof of a touch panel with contour lines Lc2. FIG. 14(c) illustrates the sizes S of change in capacitance in the horizontal direction with a graph G2.

For example, in the touch panel apparatus 201 illustrated in FIG. 10, as illustrated in FIG. 13(a), when a touch operation is performed while the stylus pen 200 is held vertically with respect to the touch surface 111 of the touch panel section 110, the distribution of the sizes S of change in capacitance caused by this touch operation is represented by contour lines Lc1 symmetrical in the left and right direction (X direction) and top and bottom direction (Y direction) with the actual touched position RTp on the touch surface 111 as the center, as illustrated in FIG. 13(b). Xp is an axis that passes through the actual touched position RTp and is parallel in the X direction, Yp is an axis that passes through the actual touched position RTp and is parallel in the Y direction, Zp is an axis that passes though the actual touched position RTp and is vertical with respect to the touch surface 111, and the Xp axis and the Yp axis are orthogonal.

In this case, in the touch panel section, the coordinate Ax for the X direction of a touched position is calculated as the middle position (Ax=(A1+A2)/2) between positions A1 and A2, the size of change in capacitance matching a predetermined threshold Sth at the positions A1 and A2. In this case, the coordinate Ax for the X direction of the detected touched position matches the coordinate for the X direction of the actual touched position RTp.

On the other hand, in the touch panel apparatus 201 illustrated in FIG. 10, as illustrated in FIG. 14(a), when a touch operation is performed while tilting the stylus pen 200 diagonally to the left with respect to the touch surface 111 of the touch panel 110, the distribution of the sizes S of change in capacitance caused by this touch operation is as shown with contour lines Lc2 in FIG. 14(b). θx represents the angle of the slope of the stylus pen 200 with respect to the touch surface 111, and in this case, the angle of the slope θx is less than 90 degrees.

In other words, the contour lines Lc2 showing the distribution of the sizes of change in capacitance caused by this touch operation is dense on the right side of a peek Sp position of change in capacitance caused by the touch operation and is sparse on the left side of this peek position, thereby forming a geometrical figure asymmetrical in the left and right direction (X direction).

In this case, in the touch panel section, the coordinate Bx for the X direction of a touched position is calculated as the middle position (Bx=(B1+B2)/2) between positions B1 and B2, the size of change in capacitance matching a predetermined threshold Sth at the positions B1 and B2. As a result, the coordinate Bx for the X direction of the detected touched position is offset to the left side from the coordinate for the X direction of the actual touched position RTp.

Dispersion occurs in the detected touched position from the tilt of the stylus pen 200 in a case where a touch operation is performed on the touch surface 111 using such a stylus pen 200. This is because, on a high precision touch panel, change in capacitance occurs on the touch panel due to not only the pen tip that is in contact with a touch surface of the touch panel, but also a conductive part of the tip section of a stylus pen in the vicinity of the touch surface, thereby the distribution of sizes of change in capacitance on the touch panel due to this conductive part is asymmetrical with respect to the touched position when the stylus pen is tilted.

Such a problem occurs similarly for the stylus pens disclosed in Patent Literature 1 and Patent Literature 2. Specifically, this is because, in the stylus pens disclosed in Patent Literature 1 and Patent Literature 2, a conductive member of the pen tip section is a conductive stick-like body, and in this case the size of the capacitance generated between a touch panel and the conductive stick-like body changes in accordance with the angle of the slope of the stylus pen.

Further, in Patent Literature 1, a stylus pen comprising a spherical conductor at the pen tip section is disclosed. However, a plurality of spherical conductors are arranged in the direction of the axis of the pen in the tip section of this stylus pen. Moreover, a connector body for connecting these spherical conductors to a hand of a person has the same diameter as the pen body. For such a configuration, the size of capacitance generated between a touch panel and the connector body or the spherical conductors changes in accordance with the angle of the slope of the stylus pen.

The present invention is intended to solve problems such as those described above. An objective of the present invention is to provide an information inputting pen that allows accurate detection of a touched position, regardless of the tilt of this information inputting pen, at the time of an operation using the information inputting pen for a capacitive touch panel.

### Solution to Problem

An information inputting pen used for inputting information on a capacitive touch panel is provided, comprising a pen body section that is held by an operator and is constituted of a non-conductive member, a pen tip section that is formed, on one end of the pen body section, to taper toward a tip side, and a spherical member that is mounted on a tip of the pen tip section and is constituted of a conductive member, where the pen body section comprises a contact member that is mounted on the pen body section to contact a hand of the operator when the operator holds the pen body section and is constituted of a conductive member, and a conductive wire disposed to penetrate through the pen body section and the pen tip section, for connecting the contact member and the spherical member, thereby achieving the objective described above.

Preferably, in an information inputting pen according to the present invention, the spherical member is made of metallic material.

Still preferably, in an information inputting pen according the present invention, the metallic material constituting the spherical member is stainless steel.

Still preferably, in an information inputting pen according to the present invention, a surface of the spherical member is covered by resin material.

Still preferably, in an information inputting pen according to the present invention, the spherical member is made of conductive resin material.

Still preferably, in an information inputting pen according to the present invention, the spherical member is rotatably mounted on the pen tip section.

Still preferably, in an information inputting pen according to the present invention, the contact member is constituted of a tubular conductive member mounted at a position at which a finger tip of the operator contacts the side of the pen tip section when the operator holds the pen body section.

Still preferably, in an information inputting pen according to the present invention, an edge on a pen tip section side of the tubular conductive member is disposed to be spaced 30 mm-40 mm from the tip of the pen tip section.

Still preferably, in an information inputting pen according to the present invention, the touch panel has a configuration comprising a plurality of first electrodes parallel to each other that extend in a first direction and a plurality of second electrodes parallel to each other that extend in a second direction, the plurality of first electrodes and plurality of second electrodes being disposed to cross in two levels, and detects a position operated by the operator from a change in capacitance generated at a part on the touch panel where the pen tip section touches or a position where the pen tip section is most closely approximated to and surrounding areas thereof when the pen tip section of the pen body section held by the operator contacts or is approximated to the touch panel, the capacitance being formed at an intersection of the first electrodes and the second electrodes.

Still preferably, in an information inputting pen according to the present invention, the respective plurality of first electrodes are made by arranging rhombus shape unit electrode sections in a longitudinal or transverse direction and electrically connecting the rhombus shape unit electrode sections to one another, adjacent first electrodes are disposed such that a diagonal side of each of the rhombus shape unit electrode sections of one of the adjacent first electrodes and a diagonal side of each of the rhombus shape unit electrode sections of the other adjacent first electrode oppose each other, the respective plurality of second electrodes are made by arranging rhombus shape unit electrode sections in a transverse or longitudinal direction and electrically connecting the rhombus shape unit electrode sections to one another, adjacent second electrodes are disposed such that a diagonal side of each of the rhombus shape unit electrode sections of one of the adjacent second electrodes and a diagonal side of each of the rhombus shape unit electrode sections of the other adjacent second electrode oppose each other, and the plurality of first electrodes and the plurality of second electrodes are disposed such that the respective rhombus shape unit electrodes of the first electrodes and the second electrodes are stacked with an insulating member interposed therebetween.

Still preferably, in an information inputting pen according to the present invention, the adjacent first electrodes are located so that an arrangement pitch of the rhombus shape unit electrode sections of one of the adjacent first electrodes is disposed to be offset half a pitch with respect to an arrangement pitch of the rhombus shape unit electrode section of the other adjacent first electrode, and the adjacent second electrodes are located so that an arrangement pitch of the rhombus shape unit electrode sections of one of the adjacent second electrodes is disposed to be offset half a pitch with respect to an arrangement pitch of the rhombus shape unit electrode section of the other adjacent second electrode.

The functions of the present invention having the configurations described above will be described hereinafter.

In the present invention, an information inputting pen comprises a pen body section that is held by an operator and is constituted of a non-conductive member, a pen tip section that is formed, on one end of the pen body section, to taper toward a tip side and is constituted of a non-conductive member, and a spherical member that is mounted on a tip of the pen tip section and is constituted of a conductive member, where a contact member is mounted on the pen body section such that a hand of an operator contacts the contact member when the operator holds the pen body section, and the contact member and the spherical member are connected by a conducting wire that penetrates through the pen body section and the pen tip section. Thus, when a touch operation is performed on the touch panel using the information inputting pen, capacitance is substantially formed only between the spherical member on the tip of the pen tip section in the information inputting pen and electrodes of the touch panel.

In other words, capacitance is not formed between a part other than the tip of the pen tip section in the information inputting pen and the electrodes of the touch panel. For this reason, even in a state where a touch operation is performed while tilting the information inputting pen diagonally with respect to a touch surface, the distribution of sizes of change in capacitance generated by this touch operation is uniform in the left and right direction and the top and bottom direction with the actual touched position on the touch surface as the center.

As a result, a touched position can be accurately detected regardless of the tilt of the information inputting pen at the time of a touch operation on a capacitive touch panel.

### Advantageous Effects of Invention

As described above, according to the present invention, an information inputting pen can be obtained that allows accurate detection of a touched position regardless of the tilt of the information inputting pen at the time of a touch operation on a capacitive touch panel.

### BRIEF DESCRIPTION OF THE DRAWINGS

FIG. 1 is a diagram describing a stylus pen according to Embodiment 1 of the present invention, and is a perspective view illustrating the exterior of a touch panel apparatus comprising this stylus pen.

FIG. 2 is a block diagram describing a touch panel apparatus comprising the stylus pen according to Embodiment 1 of the present invention, and illustrates a configuration of a touch panel constituting the touch panel apparatus.

FIG. 3 is a diagram describing a touch panel apparatus comprising the stylus pen according to Embodiment 1 of the present invention. FIG. 3(a) is a partial cutaway perspective view of a panel body in this touch panel apparatus. FIG. 3(b) is a cross-sectional view at line IIIb-IIIb′ of FIG. 3(a). FIG. 3(c) is a plan view illustrating a part of the panel body illustrated in FIG. 3(a).

FIG. 4 is a diagram describing the stylus pen according to Embodiment 1 of the present invention. FIG. 4(a) illustrates a cross-sectional structure of this stylus pen. FIG. 4(b) illustrates a state in which this stylus pen is contacting a touch surface.

FIG. 5 is a diagram describing the function of the stylus pen according to Embodiment 1 of the present invention. FIG. 5(a) illustrates a state in which a touch operation is performed with this stylus pen held vertically with respect to the touch surface. FIG. 5(b) illustrates a distribution of sizes of change in capacitance that are detected at a touched position and the vicinity thereof of the touch panel with contour lines Lc1. FIG. 5(c) illustrates the change in capacitance in the horizontal direction.

FIG. 6 is a diagram describing the function of the stylus pen according to Embodiment 1 of the present invention. FIG. 6(a) illustrates a state in which a touch operation is performed with this stylus pen tilted diagonally with respect to a touch surface. FIG. 6(b) illustrates a distribution of sizes of change in capacitance that are detected at a touched position and the vicinity thereof of the touch panel. FIG. 6(c) illustrates the change in capacitance in the horizontal direction.

FIG. 7 is a diagram describing a configuration of a stylus pen according to Embodiment 2. FIG. 7(a) illustrates a cross-sectional structure of this stylus pen. FIG. 7(b) illustrates a state in which this stylus pen is contacting a touch surface.

FIG. 8 is a diagram describing a configuration of a stylus pen according to Embodiment 3 of the present invention. FIG. 8(a) illustrates a cross-sectional structure of this stylus pen. FIG. 8(b) illustrates a detailed cross-sectional structure of the tip section of this stylus pen.

FIG. 9 is a diagram illustrating another example of a configuration of a touch panel, to which a stylus pen of any one of Embodiments 1-3 of the present invention can be applied.

FIG. 10 is a perspective view illustrating the exterior of a conventional touch panel apparatus.

FIG. 11 is a diagram describing a stylus pen disclosed in Patent Literature 1. FIG. 11 (a) illustrates the exterior of this stylus pen. FIG. 11(b) illustrates the cross-sectional structure of the pen tip section of this stylus pen.

FIG. 12 is a diagram describing a stylus pen disclosed in Patent Literature 2, and illustrates a typical cross-sectional structure of a touch panel and a stylus pen.

FIG. 13 is a diagram describing a touch operation in a convention touch panel apparatus. FIG. 13(a) illustrates a state where this stylus pen is held vertically with respect to a touch surface to perform a touch operation. FIG. 13(b) illustrates a distribution of sizes of change in capacitance that are detected at a touched position and in the vicinity thereof of a touch panel. FIG. 13(c) illustrates the change in capacitance in the horizontal direction.

FIG. 14 is a diagram describing a touch operation in a conventional touch panel apparatus. FIG. 14(a) illustrates a state where this stylus pen is tilted diagonally with respect to a touch surface to perform a touch operation. FIG. 14(b) illustrates a distribution of sizes of change in capacitance that are detected at a touched position and in the vicinity thereof of a touch panel. FIG. 14(c) illustrates the change in capacitance in the horizontal direction.

### DESCRIPTION OF EMBODIMENTS

Hereinafter, Embodiments of the present invention will be described with reference to the accompanying figures.

### Embodiment 1

FIG. 1 is a diagram describing a stylus pen as an information inputting pen according to Embodiment 1 of the present invention, and is a perspective view illustrating the exterior of a touch panel apparatus comprising this stylus pen.

This touch panel apparatus 10 comprises a capacitive touch panel 110 and a stylus pen 100 for inputting information on the touch panel 110, and is configured such that the touch panel 110 detects a position of operation by the stylus pen 100 by contacting or approximating the stylus pen 100 to a touch surface 111 of the touch panel 110.

Further, in general, such a touch panel apparatus 10 is integrated with a display apparatus (not shown), and the touch surface 111 of the touch panel apparatus is disposed to be stacked on the display surface of the display apparatus.

In an information inputting apparatus where such a touch panel apparatus 10 and the display apparatus are integrated, an operator can input information by performing a touch operation on an area displaying an operation button and the like on the display surface of the display apparatus.

FIG. 2 is a block diagram describing a touch panel apparatus comprising the stylus pen according to Embodiment 1 of the present invention, and illustrates a configuration of a touch panel constituting the touch panel apparatus.

The touch panel 110 comprises: a panel body 110a having a plurality of drive lines (first electrodes) 2 and a plurality of sense lines (second electrodes) 3; a drive line driving section 112 for applying a drive signal Ds to the drive lines 2 of the panel body 110a; and a signal processing section 120 for receiving a sense signal Ss generated by the application of this drive signal Ds from the sense lines 3 to generate touch information ISp indicating an operation position (touched position) RTp (see FIGS. 5 and 6) by signal processing to the sense signal Ss.

This signal processing section 120 comprises: an amplifier circuit 113 for amplifying the sense signal Ss from the plurality of sense lines 3; a signal selecting section 114 for sequentially selecting the amplified sense signal as from the plurality of sense lines 3 to output the selected, amplified sense signal ASs; an A/D converter section 115 for converting the sense signal as from the signal selecting section 114 to a digital signal DSs; a decode processing section 116 for decoding the digital signal DSs obtained at this A/D converter section 115 using a conversion signal for decoding based on sequence signals used for the generation of the drive signal Ds to obtain signal strength Cd corresponding to the size of change in capacitance at the intersection of the drive lines 2 and the source lines 3 in the panel body 110a; and a touched position detecting section 117 for detecting touch information ISp that indicates the touched position by an operator on the panel body 110a based on the signal strength Cd.

Here, the touch panel 110 has an identical configuration as that in a conventional touch panel apparatus 200, which has a configuration where a plurality of drive lines 2 disposed parallel to each other and a plurality of sense lines 3 disposed parallel to each other are disposed to cross in two-levels.

FIG. 3 is a diagram for describing a touch panel apparatus comprising the stylus pen according to Embodiment 1 of the present invention. FIG. 3(a) is a partial cutaway perspective view of a panel body in this touch panel apparatus. FIG. 3(b) is a cross-sectional view at line IIIb-IIIb′ of FIG. 3(a). FIG. 3(c) is a plan view illustrating a part of the panel body illustrated in FIG. 3(a).

This panel body 110a constituting a touch panel has a pair of insulating substrates 1a and 1c on the top and bottom, such as a glass substrate, that are disposed with space to oppose each other. On the bottom surface of the insulating substrate 1a of the top side, a plurality of drive lines 2 are disposed parallel in the X direction, and on the top surface of the insulating substrate to of the bottom side, a plurality of sense lines 3 are disposed parallel in the Y direction. Here, the drive lines 2 and the sense lines 3 are each constituted of a belt-shaped conductive layers, and the drive lines 2 and the sense lines 3 are insulated by an insulating layer 1b made of PET resin or the like. A capacitance Cp is formed at each intersection A where the drive lines 2 and the sense lines 3 intersect three dimensionally with an insulating layer 1b interposed therebetween. The capacitance Cp formed at each intersection A is found by analyzing signal strength, which is obtained by signal processing the above-described sense signal Ss, at an intersecting position (each coordinate of the touch panel body) where the drive lines 2 and the sense lines 3 intersect.

FIG. 4 is a diagram describing the stylus pen according to Embodiment 1 of the present invention. FIG. 4(a) illustrates a cross-sectional structure of this stylus pen. FIG. 4(b) illustrates a state in which this stylus pen is contacting a touch surface.

This stylus pen 100 comprises: a pen body 103 that is held by an operator and is constituted of non-conductive member; a pen tip section 102 that is formed, on one end of the pen body section 103, to taper towards the tip side and is constituted of a non-conductive member; and a spherical member 101 that is mounted on the tip of the pen tip section 102 and is constituted of a conductive member. Here, insulating resin or rigid plastic is used for the non-conductive member.

The pen body section 103 has a conductive contact member 104 mounted on the pen body section 103 to contact the hand of an operator when the operator holds the pen body section 103 and a conducting wire 105 disposed to penetrate through the pen body section 103 and the pen tip section 102, for connecting the contact member 104 and the spherical member 101.

Here, the spherical member 101 is a stainless steel ball. However, this spherical member 101 may be made of other metallic material, and furthermore, may be made of material other than metal, such as conductive resin material.

Further, the contact member 104 is constituted of a tubular metallic member that is mounted at the position, on the side of the pen tip section 102 of the pen body section 103, contacted by a finger tip H of an operator when the operator holds the pen body section 103.

Further, the conductive wire 105 uses a copper wire with a diameter of 0.1 mm or less. It is desirable that the diameter of a metal wire used for the conductive wire is as thin as possible in order to make the effect exerted on the capacitance formed between the drive lines 2 and the source lines 3 of the touch panel to be small. However, if durability is taken into consideration, it is difficult to use a wire that is extremely thin.

Furthermore, the tubular conductive member (contact member) 104 is mounted on the tip side of the pen body section 103 while the pen tip section side edge of the tubular conductive member is spaced 30 mm from the tip of the pen tip section. However, the distance D from the pen tip section side edge of the tubular conductive member to the tip of the pen tip section is not limited to 30 mm. It may be a distance equal to or greater than that for which the size of the capacitance formed between this tubular conductive member 104 and the touch panel is substantially not detected at the touch panel. However, if this distance D is too large, the contact member 104 does not contact the hand H of a person holding the stylus pen. Thus, the range of 30 mm to 40 mm is preferred.

Further, it is desirable that the size (diameter) of the tip of the pen tip section is equal to or less than 2 mm for writability concerns. Furthermore, if the arrangement pitch of the drive lines 2 and the sense lines 3 of the touch panel is in the range of 1 mm-2 mm, it is especially preferred that the diameter of the spherical member 101 is in the range of 1 mm to 2 mm.

For example, in a case where the diameter of the spherical member 101 is extremely small with respect to the arrangement pitch of the electrodes (or in other words, the drive lines and the source lines), the change in capacitance in the touch panel is small when the spherical member 101 is positioned at the middle position between the electrodes. In contrast, in a case where the diameter of the spherical member 101 is extremely large with respect to the arrangement pitch of the electrodes, the change in capacitance in the touch panel due to the spherical member occurs across a wide range, and thus it becomes impossible to calculate the position of the spherical member with precision. For this reason, it is desirable that the diameter of the spherical member 101 is greater than or equal to ½ of the electrode pitch and less than or equal to twice the electrode pitch.

In this manner, in Embodiment 1, only the minimum parts of the stylus pen required is formed as a conductor so that conductor parts other than the tip section of the stylus pen does not affect the touch panel. Further, the conductive spherical member 101 of the pen tip section and the contact member 104 disposed at the part of the pen body 103 that is held by a hand are linked with a thin conductive wire (about 0.1 mm), and the contact member 104 is disposed at a position as far away as possible from the pen tip.

When performing a touch operation on the touch panel 110 using the stylus pen 100 with such a configuration, as illustrated in FIG. 4(b), the hand H of a person holding the stylus pen 100 is in a state of contacting the contact member 104 of the stylus pen 100.

In this state, the capacitance of the entire body of the person is connected to the spherical member 101 on the tip of the stylus pen 100. Thus, the spherical member 101 of the stylus pen is essentially in a state of being grounded.

For this reason, when the spherical member 101 on the tip of the stylus pen 100 contacts or is approximated to the touch surface 111 of the touch panel, a large capacitance is formed between the spherical member and the drive lines 2 on the operation surface side of the touch panel. At this time, the diameter of the spherical member 101 is greater than or equal to ½ of the electrode pitch and less than or equal to twice the electrode pitch. Thus, among the intersections of the drive lines 2 and the sense lines 3, an intersection generating the largest change in capacitance by the approximation of the spherical member 101 is accurately determined.

Further, at the pen tip section 102 of the stylus pen 100, a conductive part having a large volume is only the spherical member 101, and the conductive wire 105 connected to the spherical member 101 is thin with a diameter of less than or equal to 0.1 mm while having a smaller volume in comparison to that of the spherical member 101. Thus, the change in capacitance on the touch panel due to this conductive wire 105 is much smaller in comparison to that due to the spherical member 101.

Thus, even if change in capacitance on the touch panel due to the conductive wire 105 occurs from the difference in the angle of the stylus pen 100, the change in capacitance on the touch panel is of a minor amount. Thus, a detection error of the touched position on the touch panel does not occur.

FIG. 5 is a diagram describing the function of the stylus pen according to Embodiment 1. FIG. 5(a) illustrates a state in which a touch operation is performed with this stylus pen held vertically with respect to the touch surface. FIG. 5(b) illustrates a distribution of sizes of change in capacitance that are detected at a touched position and the vicinity thereof of the touch panel with contour lines Lc1. FIG. 5(c) illustrates the sizes S of change in capacitance in the horizontal direction with a graph G1.

FIG. 6 is a diagram describing the function of the stylus pen according to Embodiment 1 of the present invention. FIG. 6(a) illustrates a state in which a touch operation is performed with this stylus pen tilted diagonally with respect to a touch surface. FIG. 6(b) illustrates a distribution of sizes of change in capacitance that are detected at a touched position and the vicinity thereof of the touch panel with contour lines Lc1a. FIG. 6(c) illustrates the sizes S of change in capacitance in the horizontal direction with a graph G3.

For example, in the touch panel apparatus 10 illustrated in FIG. 1, as illustrated in FIG. 5(a), when a touch operation is performed with the stylus pen 100 held vertically with respect to the touch surface 111 of the touch panel 110, the distribution of the sizes S of change in capacitance generated by this touch operation, as illustrated in FIG. 5(b), is as represented by contour lines Lc1 that are symmetrical in the left and right direction (X direction) and the top and bottom direction (Y direction) with the actual touched position RTp on the touch surface 111 as the center.

In this case, on the touch panel 110, a coordinate Ax for the X direction of the touched position is calculated as the coordinate Ax (=(A1+A2)/2), which is the middle position of positions A1 and A2, the size of change in capacitance matching a threshold Sth at the positions A1 and A2. The coordinate Ax for the X direction of the detected touched position matches the coordinate for the X direction of the actual touched position RTp.

Further, in the touch panel apparatus 10 of Embodiment 1, as illustrated in FIG. 6(a), when a touch operation is performed while the stylus pen 100 is tilted diagonally to the left with respect to the touch surface 111 of the touch panel section 110, the distribution of the sizes S of change in capacitance generated by this touch operation is as shown by the contour lines Lc1a illustrated in FIG. 6(b). In FIG. 6, θx is the angle of slope of the stylus pen 100 with respect to the touch surface 111.

In other words, for the stylus pen 100 of Embodiment 1, since the conductive body of the pen tip section 102 is the spherical member 101, even if the stylus pen is tilted, there is hardly any change in capacitance between this spherical member 101 and the electrodes (drive lines or source lines) of the touch panel. Further, since this spherical member 101 and the contact member 104 of the pen body section 103 are connected by the thin conductive wire 105, the change in capacitance between this conductive wire 105 and the electrodes of the touch panel is very small.

For this reason, the contour lines Lc1a showing the distribution of the sizes S of change in capacitance generated by a touch operation become a substantially symmetrical diagram in the left and right direction (X direction), as the degree of density on the right side of the peek position of change in capacitance that is generated by a touch operation and that on the left side of this peek position becomes about the same.

In this case, on the touch panel section, a coordinate Cx for the X direction of a touched position is calculated as coordinate Cx (=(C1+C2)/2), which is the middle position of positions C1 and C2, where the size of change in capacitance matches a threshold Sth. As a result, the coordinate Cx for the X direction of the detected touched position substantially matches the coordinate for the X direction of the actual touched position RTp.

In this manner, the stylus pen 100 of Embodiment 1 comprises the pen body section 103 that is held by an operator and is constituted of a non-conductive member, the pen tip section 102 that is formed, on one end of the pen body section 103, to taper towards the tip side and is constituted of a non-conductive member, and the spherical member 101 that is mounted on the tip of the pen tip section and is constituted of a conductive member; the contact member 104 is mounted on the pen body section 103 so that the hand H of an operator contacts the contact member 104 when the operator holds the pen body section; and the contact member 104 and the spherical member 101 are connected by the conductive wire 105 that penetrates though the pen body section 103 and the pen tip section 102. Thus, when a touch operation is performed on the touch panel 110 using the stylus pen 100, capacitance is essentially formed only between the spherical member 101 on the tip of the pen tip section 102 and the touch panel 110.

By devising the configuration of the stylus pen 100 in such a manner, input information can be obtained on a capacitive touch panel without inducing a decrease in detection precision of a touched position due to the stylus pen 100 tilting.

As a result, a touched position can be accurately detected regardless of the tilt of the stylus pen at the time of a touch operation on a capacitive touch panel.

The stylus pen 100 of the above-described Embodiment 1 has a configuration where the spherical member of the pen tip section directly contacts the touch surface of the touch panel. However, the spherical member of this pen tip section may be of a configuration with the surface of the spherical member covered by resin material.

In this case, there is an effect of preventing a formation of a scratch on the touch panel due to the contact of the touch panel and the spherical member on the pen tip section of the stylus pen.

The above-described Embodiment 1 shows a case where a touch operation is performed by contacting the stylus pen with the touch panel. However, in a high precision touch panel, the touch panel can detect the position of the stylus pen even in a state where the stylus pen is approximated to the touch panel, without the stylus pen contacting the touch panel. Even in an operation with a stylus pen where the stylus pen is approximated to a high precision touch panel, a position of the pen tip of the stylus pen can be accurately detected on the touch panel, regardless of the tilt of the stylus pen.

### Embodiment 2

FIG. 7 is a diagram describing a configuration of a stylus pen according to Embodiment 2. FIG. 7(a) illustrates a cross-sectional structure of this stylus pen. FIG. 7(b) illustrates a state in which this stylus pen is contacting a touch surface.

This stylus pen 100a according to Embodiment 2 has a configuration where a spherical member 101a is completely embedded in the tip side of a pen tip section 102a, instead of a configuration where the spherical member 101 is held on the tip of the pen tip section 102 in the stylus pen 100 of Embodiment 1.

In other words, this stylus pen 100a of Embodiment 2, similarly to the stylus pen 100 if Embodiment 1, comprises a pen body section 103 that is held by an operator and is constituted of a non-conductive member and the pen tip section 102a that is formed, on the side of one end of the pen body section 103, to taper towards the tip side and is constituted of a non-conductive member.

In this stylus pen 100a of Embodiment 2, the pen tip section 102a has a configuration where the spherical member 101a constituted of a non-conductive member is embedded in the tip section of the pen tip section 102a.

Here, a stainless steel ball is used for the spherical member 101a, and this spherical member 101a is connected to a connecting member 104 of the pen body section 103 by a conductive wire 105.

Other configuration of this stylus pen of Embodiment 2 is identical to the stylus pen 100 of Embodiment 1.

In the stylus pen 100a according to Embodiment 2 with such a configuration, the pen tip section 102a has a configuration where a stainless steel ball as the spherical member 101a is embedded in the tip section of the pen tip section 102a, and thus can be formed in a stylish shape with a thinned tip of the pen tip section. Furthermore, direct contact of the stainless steel ball as the spherical member 101a to a touch surface of a touch panel can be avoided and scratching of the touch surface of the touch panel due to a contact of the touch panel and the stylus pen can be prevented.

Further, in the stylus pen 100a with such a configuration, when a touch operation is performed with the stylus pen, the spherical member 101a is in a state in which the spherical member 101a is floating above the touch surface of the touch panel for a certain distance. When the stylus pen 100a is tilted, the center of the spherical member is displaced with respect to a touched position on the touch surface by the stylus pen. However, it is possible to substantially avoid detection errors due to the angle of the slope of the stylus pen by making the distance from the tip of the stylus pen to the center of the spherical member to be small.

### Embodiment 3

FIG. 8 is a diagram describing a configuration of a stylus pen according to Embodiment 3 of the present invention. FIG. 8(a) illustrates a cross-sectional structure of this stylus pen. FIG. 8(b) illustrates a detailed cross-sectional structure of the tip section of this stylus pen.

This stylus pen 100b of Embodiment 3 comprises a pen tip section 102b that rotatably holds a spherical member 101b, instead of the pen tip section 102 in the stylus pen 100 of Embodiment 1. Other configurations are identical to the stylus pen in Embodiment 1.

In other words, this stylus pen 100b of Embodiment 3 comprises: a pen body section 103 that is held by an operator and is constituted of a non-conductive member; the pen tip section 102b that is formed, on one end of the pen body section 103, to taper towards the tip side and constituted of a non-conductive member; and the spherical member 101b that is rotatably mounted on the tip of the pen tip section 102b and is constituted of a conductive member. Here, insulating resin or rigid plastic is used for a non-conductive member.

Further, the pen tip section 102b comprises the seat section 102b1 that rotatably supports the spherical member 101b and is constituted of a conductive member and a support section 102b2 that supports this seat section 102b1 and is constituted of an insulating member. Here, the diameter Wp of the spherical member 101b is less than that of the tip of the pen tip section 102b.

Similarly to the stylus pen 100 of Embodiment 1, the pen body section 103 comprises a contact member 104 mounted on the pen body section to contact the hand of an operator when the operator holds the pen body section and a conducting wire 105 that is disposed to penetrate through the pen body section 103 and the pen tip section 102b to connect the contact member 104 and the spherical member 101b.

In the stylus pen 100b of Embodiment 3 with such a configuration, the spherical member 101b is rotatably mounted on the pen tip section 102b. Thus, the spherical member 101b that is mounted on the tip of the pen tip section 102b rotates at the time of a touch operation on the touch panel. For this reason, the touch surface of the touch panel and the spherical member 101b do not chafe against each other, thereby a touch operation can be performed smoothly. In addition, there is an effect of preventing the formation of a scratch on the touch surface of the touch panel due to friction created between the touch surface of the touch panel and the spherical member on the tip of the stylus pen.

The above-described Embodiments 1-3 shows, as a panel body section of a touch panel, those with a configuration having, as illustrated in FIG. 3, a plurality of drive lines constituted of a belt-shaped conductive layer and a plurality of sense lines constituted of a belt-shaped conductive layer, which are crossed in two levels to form capacitance at the intersections thereof. However, the panel body section of the touch panel is not limited to those with such a configuration.

FIG. 9 is a diagram illustrating another example of a configuration of a touch panel, to which a stylus pen of any one of Embodiments 1-3 of the present invention can be applied.

The panel body 110b of this touch panel has a configuration comprising a plurality of first electrodes (drive lines) 2a1, 2a2 parallel to each other that extend in a first direction and a plurality of second electrodes (sense lines) 3a1, 3a2 parallel to each other that extend in a second direction, the plurality of drive lines and plurality of sense lines being disposed to cross in two levels.

Here, each drive line is made by arranging a rhombus shape unit electrode sections 2a11 in a transverse direction (X direction) and electrically connecting them to each other by a connecting section 2a12. For adjacent drive lines 2a1 and 2a2, an arrangement pitch of the rhombus shape unit electrode sections 2a11 is offset by half a pitch such that a diagonal side of each of the rhombus shape unit electrode sections 2a11 of one of the adjacent drive lines 2a1 and a diagonal side of each of the rhombus shape unit electrode sections 2a11 of the other adjacent drive line 2a2 oppose each other.

Similarly, each source line 3a1, 3a2 is made by arranging a rhombus shape unit electrode sections 3a11 in a longitudinal direction (Y direction) and electrically connecting them to each other by a connecting section 3a12. For adjacent source lines 3a1 and 3a2, an arrangement pitch of the rhombus shape unit electrode sections 3a11 is offset by half a pitch such that a diagonal side of each of the rhombus shape unit electrode sections 3a11 of one of the adjacent source lines 3a1 and a diagonal side of each of the rhombus shape unit electrode sections 3a11 of the other adjacent source line 3a2 oppose each other.

In addition, the plurality of drive lines 2a1, 2a2 and the plurality of source lines 3a1, 3a2 are disposed such that the respective rhombus shape unit electrodes 2a11 and 3a11 are stacked with an insulating member interposed therebetween.

In such a panel body 110b, when the pen tip section of the stylus pen held by an operator contacts or is approximated to the touch panel, a change in capacitance occurs at apart on the touch panel where the pen tip section touches or a position where the pen tip section is most closely approximated and the surrounding area thereof. For the configuration of the panel body section 110b illustrated in FIG. 9, the arrangement density of the intersection between the plurality of drive lines 2a1, 2a2 and the plurality of source lines 3a1, 3a2 is high, and a touched position by the stylus pen can be detected at a higher sensitivity. Thus, the configuration of the stylus pen that inhibits the dispersion in detected positions of touched positions due to the tilt at the time of the operation in the Embodiment described above becomes more meaningful.

As described above, the present invention is exemplified by the use of its preferred Embodiments. However, the present invention should not be interpreted solely based on the Embodiments described above. It is understood that the scope of the present invention should be interpreted solely based on the claims. It is also understood that those skilled in the art can implement an equivalent scope of technology, based on the description of the present invention and common knowledge from the detailed description of the preferred Embodiments of the present invention. Furthermore, it is understood that any patent, any patent application, and any references cited in the present specification should be incorporated by reference in the present specification in the same manner as the contents are specifically described therein.

### INDUSTRIAL APPLICABILITY

The present invention can be applied in the field of information inputting pens. The present invention provides an information inputting pen that allows accurately detecting a touched position, regardless of a tilt of a stylus pen at the time of a touch operation on a capacitive touch panel.

### REFERENCE SIGNS LIST

1a, 1c insulating substrate
2, 2a1, 2a2 drive line (first electrode)
2a11, 3a11 unit electrode section
2a12, 3a12 connecting section
3, 3a1, 3a2 sense line (second electrode)
10 touch panel apparatus
100, 100a, 100b information inputting pen (stylus pen)
101, 101a, 101b spherical member
102, 102a, 102b pen tip section
102b1 seat section
102b2 support section
103 pen body section
104 contact member
105 conductive wire
110 touch panel
110a, 110b panel body
111 touch surface
112 drive line driving section
113 amplifier circuit
114 signal selecting section
115 A/D converter section
116 decode processing section
117 touched position detecting section
120 signal processing section
A intersection
Cp capacitance
H hand of person

1-11. (canceled)

12. An information inputting pen used for inputting information on a capacitive touch panel, comprising
a pen body section that is held by an operator and is constituted of a non-conductive member,
a pen tip section that is formed, on one end of the pen body section, to taper toward a tip side, and
a spherical member that is mounted on a tip of the pen tip section and is constituted of a conductive member,
wherein the pen body section comprises
a contact member that is mounted on the pen body section to contact a hand of the operator when the operator holds the pen body section and is constituted of a conductive member, and
a conductive wire disposed to penetrate through the pen body section and the pen tip section, for connecting the contact member and the spherical member.

13. An information inputting pen according to claim 12, wherein the spherical member is made of metallic material.

14. An information inputting pen according to claim 13, wherein the metallic material constituting the spherical member is stainless steel.

15. An information inputting pen according to claim 13, wherein a surface of the spherical member is covered by resin material.

16. An information inputting pen according to claim 12, wherein the spherical member is made of conductive resin material.

17. An information inputting pen according to claim 12, wherein the spherical member is rotatably mounted on the pen tip section.

18. An information inputting pen according to claim 12, wherein the contact member is constituted of a tubular conductive member mounted at a position at which a finger tip of the operator contacts the side of the pen tip section when the operator holds the pen body section.

19. An information inputting pen according to claim 18, wherein an edge on a pen tip section side of the tubular conductive member is disposed to be spaced 30 mm-40 mm from the tip of the pen tip section.

20. An information inputting pen according to claim 12, wherein the touch panel
has a configuration comprising a plurality of first electrodes parallel to each other that extend in a first direction and a plurality of second electrodes parallel to each other that extend in a second direction, the plurality of first electrodes and plurality of second electrodes being disposed to cross in two levels, and
detects a position operated by the operator from a change in capacitance generated at a part on the touch panel where the pen tip section touches or a position where the pen tip section is most closely approximated to and surrounding areas thereof when the pen tip section of the pen body section held by the operator contacts or is approximated to the touch panel, the capacitance being formed at an intersection of the first electrodes and the second electrodes.

21. An information inputting pen according to claim 20, wherein
the respective plurality of first electrodes are made by arranging rhombus shape unit electrode sections in a longitudinal or transverse direction and electrically connecting the rhombus shape unit electrode sections to one another,
adjacent first electrodes are disposed such that a diagonal side of each of the rhombus shape unit electrode sections of one of the adjacent first electrodes and a diagonal side of each of the rhombus shape unit electrode sections of the other adjacent first electrode oppose each other,
the respective plurality of second electrodes are made by arranging rhombus shape unit electrode sections in a transverse or longitudinal direction and electrically connecting the rhombus shape unit electrode sections to one another,
adjacent second electrodes are disposed such that a diagonal side of each of the rhombus shape unit electrode sections of one of the adjacent second electrodes and a diagonal side of each of the rhombus shape unit electrode sections of the other adjacent second electrode oppose each other, and
the plurality of first electrodes and the plurality of second electrodes are disposed such that the respective rhombus shape unit electrodes of the first electrodes and the second electrodes are stacked with an insulating member interposed therebetween.

22. An information inputting pen according to claim 21, wherein,
the adjacent first electrodes are located so that an arrangement pitch of the rhombus shape unit electrode sections of one of the adjacent first electrodes is disposed to be offset half a pitch with respect to an arrangement pitch of the rhombus shape unit electrode section of the other adjacent first electrode, and
the adjacent second electrodes are located so that an arrangement pitch of the rhombus shape unit electrode sections of one of the adjacent second electrodes is disposed to be offset half a pitch with respect to an arrangement pitch of the rhombus shape unit electrode section of the other adjacent second electrode.
